(19) United States
(12) Patent Application Publication
(10) Pub. No.: US 2012/0162528 A1
(43) Pub. Date: Jun. 28, 2012

(54) VIDEO PROCESSING DEVICE AND VIDEO DISPLAY DEVICE

(76) Inventors: Shinya Kiuchi, Osaka (JP); Mitsuhiro Mori, Osaka (JP)

(21) Appl. No.: 13/393,690

(22) PCT Filed: Jan. 6, 2011
(86) PCT No.: PCT/JP2011/000026

§ 371 Date: Mar. 1, 2012

(30) Foreign Application Priority Data
Jan. 13, 2010 (JP) 2010-004820

(51) Int. Cl. H04N 5/00

(52) U.S. Cl. 348/607; 348/E05.001

(57) ABSTRACT

Provided are a video processing device and a video display device capable of inhibiting the degradation of image quality and improving the video resolution. The video processing device has a motion vector detection unit (2) which detects a motion vector using at least two or more time-sequential input images, a low visual saliency area detection unit (3) which detects a low visual saliency area having a low visual saliency in an input image, and a motion vector correction unit (4) which corrects the motion vector detected by the motion vector detection unit (2) so that the motion vector decreases in the low visual saliency area detected by the low visual saliency area detection unit (3).

### TECHNICAL FIELD

The present invention relates to a video processing device which processes input images so as to improve the level of the video image quality based on motion vectors, and to a video display device.

### BACKGROUND ART

In recent years, plasma display devices and liquid crystal display devices are attracting attention as display devices.

A liquid crystal display device displays video by irradiating light from a backlight device to a liquid crystal panel, changing the voltage applied to the liquid crystal panel so as to change the liquid crystal orientation, and increasing or decreasing the transmittance of light.

A plasma display device has advantages in that it can achieve a thin profile and a large screen, and an AC-type plasma display panel that is used in this kind of plasma display device displays video by forming discharge cells in a matrix by combining a front face plate made of a glass substrate in which a plurality of scanning electrodes and sustaining electrodes are arranged thereon and a rear face plate in which a plurality of data electrodes so that the scanning electrodes and the sustaining electrodes, and the data electrodes, become orthogonal.

Upon displaying video as described above, one field is divided in a time direction into a plurality of screens (hereinafter referred to as “sub fields (SF)”) having different weights of luminance, and, by controlling the emission or non-emission of the discharge cells in the respective sub fields, an image of one field; that is, a one frame image is displayed.

With a video display device using the foregoing sub field division, there is a problem in that a tone jump known as dynamic false contours and video blur occur upon displaying a video image, and the display quality level is thereby diminished. In order to reduce the occurrence of such dynamic false contours, for example, Patent Literature 1 discloses an image display device which detects a motion vector with pixels of one field as the starting point and pixels of another field as the end point among a plurality of fields contained in the video image, converts the video image into emission data of the sub fields, and reconfigures the emission data of the sub fields via processing using the motion vector.

With this conventional image display device, the occurrence of video blur and dynamic false contours is inhibited by selecting a motion vector with the reconfiguration target pixels of the other field among the motion vectors as the end point, calculating a position vector by multiplying a predetermined function thereto, and reconfiguring the emission data of one sub field of the reconfiguration target pixels into emission data of the sub field of the pixels indicated by the position vector.

As described above, with a conventional image display device, the video image is converted into emission data of the respective sub fields, and the emission data of the respective sub fields is rearranged according to the motion vector. The method of rearranging the emission data of the respective sub fields is now explained in detail below.

FIG. 15 is a schematic diagram showing an example of the transitional state of the display screen, FIG. 16 is a schematic diagram explaining the emission data of the respective sub fields before rearranging the emission data of the respective sub fields upon displaying the display screen shown in FIG. 15, and FIG. 17 is a schematic diagram explaining the emission data of the respective sub fields after rearranging the emission data of the respective sub fields upon displaying the display screen shown in FIG. 15.

Considered is a case where, as shown in FIG. 15, as successive frame images, an N-2 frame image D1, an N-1 frame image D2, and an N frame image D3 are displayed in order, an entire screen in a black state (for instance, luminance level of 0) is displayed as the background, and a mobile object OJ of a white circle (for instance, luminance level of 255) moves from left to right as the foreground.

Foremost, the foregoing conventional image display device converts the video image into emission data of the respective sub fields and, as shown in FIG. 16, the emission data of the respective sub fields of the respective pixels is created for the respective frames as follows.

Here, when displaying the N-2 frame image D1, on the assumption that one field is configured from five sub fields SF1 to SF5, foremost, in the N-2 frame, the emission data of all sub fields SF1 to SF5 of the pixel P-10 corresponding to the mobile object OJ becomes a light-emitting state (sub fields that are hatched in the diagram), and the emission data of the sub fields SF1 to SF5 of the other pixels becomes a non-light-emitting state (not shown). Subsequently, in the N-1 frame, when the mobile object OJ moves horizontally in a distance corresponding to five pixels, the emission data of all sub fields SF1 to SF5 of the pixel P-5 corresponding to the mobile object OJ becomes a light-emitting state, and the emission data of the sub fields SF1 to SF5 of the other pixels becomes a non-light-emitting state. Subsequently, in the N frame, when the mobile object OJ additionally moves horizontally in a distance corresponding five pixels, the emission data of all sub fields SF1 to SF5 of the pixel P-0 corresponding to the mobile object OJ becomes a light-emitting state, and the emission data of the sub fields SF1 to SF5 of the other pixels becomes a non-light-emitting state.

Subsequently, the foregoing conventional image display device rearranges the emission data of the respective sub fields according to the motion vector and, as shown in FIG. 17, the rearranged emission data of the respective sub fields of the respective pixels is created for the respective frames as follows.

Foremost, when a shift in the horizontal direction in a distance corresponding to five pixels is detected as a motion vector V1 from the N-2 frame and the N-1 frame, in the N-1 frame, the emission data (light-emitting state) of the first sub field SF1 of the pixel P-5 is moved leftward in a distance corresponding to four pixels, the emission data of the first sub field SF1 of the pixel P-9 is changed from a non-light-emitting state to a light-emitting state (sub fields that are hatched in the diagram), and the emission data of the first sub field SF1 of the pixel P-5 is changed from a light-emitting state to a non-light-emitting state (sub fields outlined with a broken line).

Moreover, the emission data (light-emitting state) of the second sub field SF2 of the pixel P-5 is moved leftward in a distance corresponding to three pixels, the emission data of the second sub field SF2 of the pixel P-8 is changed from a non-light-emitting state to a light-emitting state, and the emission data of the second sub field SF2 of the pixel P-5 is changed from a light-emitting state to a non-light-emitting state.

Moreover, the emission data (light-emitting state) of the third sub field SF3 of the pixel P-5 is moved leftward in a distance corresponding to two pixels, the emission data of the third sub field SF3 of the pixel P-7 is changed from a non-light-emitting state to a light-emitting state, and the emission data of the third sub field SF3 of the pixel P-5 is changed from a light-emitting state to a non-light-emitting state.

Moreover, the emission data (light-emitting state) of the fourth sub field SF4 of the pixel P-5 is moved leftward in a distance corresponding to one pixel, the emission data of the fourth sub field SF4 of the pixel P-6 is changed from a non-light-emitting state to a light-emitting state, and the emission data of the fourth sub field SF4 of the pixel P-5 is changed from a light-emitting state to a non-light-emitting state. Moreover, the emission data of the fifth sub field SF5 of the pixel P-5 is not changed.

Similarly, when a shift in the horizontal direction in a distance corresponding to five pixels is detected as a motion vector V2 from the N-1 frame and the N frame, the emission data (light-emitting state) of the first to fourth sub fields SF1 to SF4 of the pixel P-0 is moved leftward in a distance corresponding to four pixels to one pixel, the emission data of the first sub field SF1 of the pixel P-4 is changed from a non-light-emitting state to a light-emitting state, the emission data of the second sub field SF2 of the pixel P-3 is changed from a non-light-emitting state to a light-emitting state, the emission data of the third sub field SF3 of the pixel P-2 is changed from a non-light-emitting state to a light-emitting state, the emission data of the fourth sub field SF4 of the pixel P-1 is changed from a non-light-emitting state to a light-emitting state, the emission data of the first to fourth sub fields SF1 to SF4 of the pixel P-0 is changed from a light-emitting state to a non-light-emitting state, and the emission data of the fifth sub field SF5 is not changed.

Based on the foregoing sub field rearrangement processing, when the viewer views the display image of making a transition from the N-2 frame to the N frame, the line of sight direction will move smoothly along the arrow AR direction, and it is thereby possible to inhibit the occurrence of video blur and dynamic false contours.

Moreover, in order to reduce the occurrence of dynamic false contours, for instance, Patent Literature 2 discloses an image display device which detects a motion vector of pixels between frames, and corrects the light-emitting position of the sub field light emission pattern according to the detected motion vector.

With this conventional image display device, the occurrence of video blur and dynamic false contours is inhibited by using a coefficient that is smaller than 1 when the level of the detected motion vector is smaller than a threshold and thereby attenuating the motion vector, and thereafter correcting the light-emitting position of the sub field light emission pattern.

With the sub field rearrangement processing of foregoing Patent Literature 1, the video resolution is improved when the direction of the motion vector of the video image and the moving direction of the viewer's line of sight are consistent. Nevertheless, when the direction of the motion vector of the video image and the moving direction of the viewer's line of sight are inconsistent, while the video resolution is improved, there is a possibility that the image quality may deteriorate.

Specifically, when displaying a video which captured a person moving at a fast speed using a camera, the person displayed at the center of the screen remains stationary, while the background portion around that person is moving at a fast speed. Here, since the line of sight of the viewer who is watching the person remains stationary, the direction of the motion vector of the video image of the background portion and the moving direction of the viewer's line of sight will be inconsistent, roughness will arise in the background portion of the display screen, and the image quality will thereby deteriorate.

FIG. 18 is a schematic diagram showing an example of the transitional state of the display screen when the direction of the motion vector of the video image and the moving direction of the viewer's line of sight do not coincide, FIG. 19 is a schematic diagram explaining the emission data of the respective sub fields before rearranging the emission data of the respective sub fields upon displaying the display screen shown in FIG. 18, and FIG. 20 is a schematic diagram explaining the emission data of the respective sub fields after rearranging the emission data of the respective sub fields upon displaying the display screen shown in FIG. 18.

Considered is a case where, as shown in FIG. 18, as successive frame images, an N-2 frame image D1′, an N-1 frame image D2′, and an N frame image D3′ are displayed in order, a background image BG having a predetermined luminance moves in an arrow Y direction, and a foreground image FG remains stationary at the center of the display screen.

Foremost, the foregoing conventional image display device converts the video image into emission data of the respective sub fields and, as shown in FIG. 19, the emission data of the respective sub fields of the respective pixels is created for the respective frames as follows. Note that FIG. 19 and FIG. 20 show the emission data of the respective sub fields in the background image BG of FIG. 18.

For example, when the background image BG is positioned on the pixels P-0 to P-6 as the spatial position on the display screen (position in the horizontal direction x), as shown in FIG. 19, emission data in which the first to fifth and seventh sub fields SF1 to SF5, SF7 of the pixels P-0, P-2, P-4, P-6 are set to a light-emitting state (sub fields that are hatched in the diagram), and the sixth sub field SF6 of the pixels P-0, P-2, P-4, P-6 is set to a non-light-emitting state (sub fields that are outlined in the diagram) is generated. Moreover, emission data in which the first to sixth sub fields SF1 to SF6 of the pixels P-1, P-3, P-5 are set to a light-emitting state, and the seventh sub field SF7 of the pixels P-1, P-3, P-5 is set to a non-light-emitting state is generated. In the foregoing case, the pixels P-0 to P-6 will emit light based on a uniform brightness.

Subsequently, the sub fields to emit light among the sub fields of the respective pixels of the frame image to be displayed are identified, and, according to the arrangement sequence of the first to seventh sub fields SF1 to SF7, the emission data of the sub fields corresponding to the pixels positioned in a manner of being spatially moved rearward in a distance of the pixels corresponding to the motion vector is changed so that the temporally preceding sub field moves a greater distance.

For example, when the shift of the pixels corresponding to the motion vector V is seven pixels, as shown in FIG. 20, the emission data of the first to sixth sub fields SF1 to SF6 of the pixels P-0 to P-6 moves rightward in a distance corresponding to six pixels to one pixel. Consequently, the emission data of the sixth sub field SF6 of the pixels P-0, P-2, P-4, P-6 is changed from a non-light-emitting state to a light-emitting state, and the emission data of the sixth sub field SF6 of the pixels P-1, P-3, P-5 is changed from a light-emitting state to a non-light-emitting state.

When the direction of the motion vector of the video image and the moving direction of the viewers line of sight do not coincide, the pixels P-0, P-2, P-4, P-6 are displayed with high luminance since the emission data of all sub fields is in a light-emitting state, and the pixels P-1, P-3, P-5 are displayed with low luminance since the emission data of the first to fifth sub fields SF1 to SF5 is in a light-emitting state and the emission data of the sixth to seventh sub fields SF6 to SF7 is in a non-light-emitting state. Accordingly, with the pixels P-0 to P-6, high luminance and low luminance are repeated alternately, and, when the user's line of sight remains stationary relative to the moving image, roughness will arise and the image quality will deteriorate.

### CITATION LIST

### Patent Literature

Patent Literature 1: Japanese Patent Application Publication No. 2008-209671
Patent Literature 2: Japanese Patent Application Publication No. 2008-256986

### SUMMARY OF INVENTION

The present invention was devised to resolve the foregoing problems, and its object is to provide a video processing device and a video display device capable of inhibiting the degradation of image quality and improving the video resolution.

The video processing device according to one aspect of the present invention comprises a motion vector detection unit which detects a motion vector using at least two or more time-sequential input images, a low visual saliency area detection unit which detects a low visual saliency area having a low visual saliency in the input image, and a motion vector correction unit which corrects the motion vector detected by the motion vector detection unit so that the motion vector decreases in the low visual saliency area detected by the low visual saliency area detection unit.

According to the foregoing configuration, the motion vector is detected using at least two or more time-sequential input images, the low visual saliency area having a low visual saliency, which represents the user's level of attention, in the input image is detected, and correction is performed so that the detected motion vector decreases in the detected low visual saliency area.

According to the present invention, since correction is performed so that the motion vector decreases in the low visual saliency area, which represents the user's level of attention, in the input image, it is possible to inhibit the degradation of image quality that occurs in the low visual saliency area having a low visual saliency, and additionally improve the video resolution.

### BRIEF DESCRIPTION OF DRAWINGS

FIG. 1 is a block diagram showing the configuration of the video display device according to the first embodiment of the present invention.

FIG. 2 is a diagram showing the specific configuration of the low visual saliency area detection unit shown in FIG. 1.

FIG. 3 is a diagram showing the relation of the luminance value of the edge and the correction gain in the first embodiment.

FIG. 4 is a diagram showing the specific configuration of the low visual saliency area detection unit in the first modified example.

FIG. 5 is a diagram showing the relation of the saturation and the correction gain in the first modified example.

FIG. 6 is a diagram showing the specific configuration of the low visual saliency area detection unit in the second modified example.

FIG. 7 is a diagram showing the relation of the level of the motion vector and the correction gain in the second modified example.

FIG. 8 is a block diagram showing the configuration of the video display device according to the second embodiment of the present invention.

FIG. 9 is a schematic diagram showing an example of the video image data.

FIG. 10 is a schematic diagram showing an example of the emission data of the sub fields relative to the video image data shown in FIG. 9.

FIG. 11 is a schematic diagram showing an example of the rearranged emission data resulting from rearranging the emission data of the sub fields shown in FIG. 10.

FIG. 12 is a diagram showing the specific configuration of the low visual saliency area detection unit shown in FIG. 8.

FIG. 13 is a diagram showing the relation of the luminance and the correction gain in the second embodiment.

FIG. 14 is a schematic diagram explaining the emission data of the respective sub fields after rearranging the emission data of the respective sub fields shown in FIG. 19 based on the corrected motion vector.

FIG. 15 is a schematic diagram showing an example of the transitional state of the display screen.

FIG. 16 is a schematic diagram explaining the emission data of the respective sub fields before rearranging the emission data of the respective sub fields upon displaying the display screen shown in FIG. 15.

FIG. 17 is a schematic diagram explaining the emission data of the respective sub fields after rearranging the emission data of the respective sub fields upon displaying the display screen shown in FIG. 15.

FIG. 18 is a schematic diagram showing an example of the transitional state of the display screen when the direction of the motion vector of the video image and the moving direction of the viewer's line of sight do not coincide.

FIG. 19 is a schematic diagram explaining the emission data of the respective sub fields before rearranging the emission data of the respective sub fields upon displaying the display screen shown in FIG. 18.

FIG. 20 is a schematic diagram explaining the emission data of the respective sub fields after rearranging the emission data of the respective sub fields upon displaying the display screen shown in FIG. 18.

### DESCRIPTION OF EMBODIMENTS

Embodiments of the present invention are now explained with reference to the appended drawings. Note that the ensuing embodiments are merely examples that embody the present invention, and are not intended to limit the technical scope of the present invention in any way.

### First Embodiment

In the first embodiment, a liquid crystal display device is explained as an example of a video display device, but the video display device to which the present invention is applied is not particularly limited to this example and, for instance, can also be similarly applied to an organic EL display.

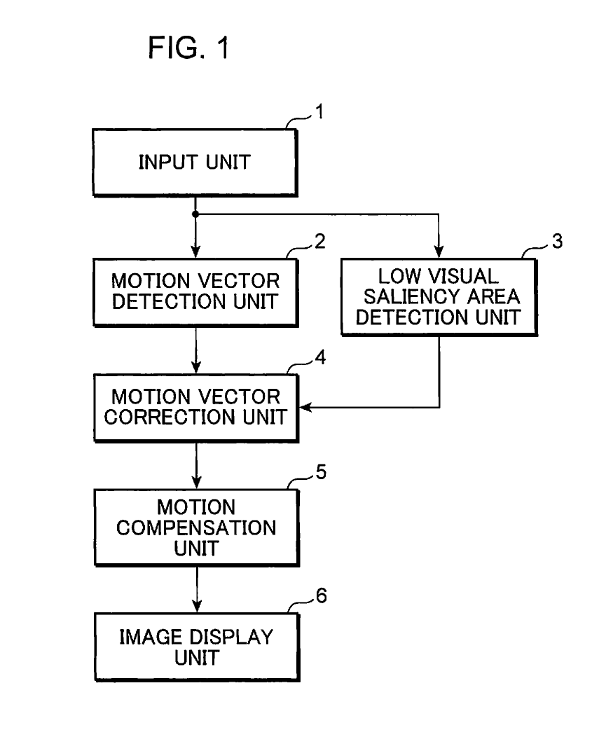

FIG. 1 is a block diagram showing the configuration of the video display device according to the first embodiment of the present invention. The video display device shown in FIG. 1 comprises an input unit 1, a motion vector detection unit 2, a low visual saliency area detection unit 3, a motion vector correction unit 4, a motion compensation unit 5 and an image display unit 6. Moreover, the motion vector detection unit 2, the low visual saliency area detection unit 3, the motion vector correction unit 4 and the motion compensation unit 5 configure a video processing device which processes input images so as to improve the quality level of the video image quality based on motion vectors.

The input unit 1 comprises, for example, a TV broadcast tuner, an image input terminal and a network connection terminal, and video image data is input into the input unit 1. The input unit 1 performs well-known conversion processing and the like to the input video image data, and outputs the frame image data, which was subject to conversion processing, to the motion vector detection unit 2 and the low visual saliency area detection unit 3.

The motion vector detection unit 2 is input with two frame image data which are temporally successive; for instance, image data of a frame N-1 and image data of a frame N (here, N is an integer), and the motion vector detection unit 2 detects the motion vector per pixel of the frame N by detecting the motion between these frames, and outputs this to the motion vector correction unit 4. As this motion vector detection method, a well-known motion vector detection method is adopted and, for example, a detection method based on the matching processing per block is used.

The low visual saliency area detection unit 3 detects a low visual saliency area having a low visual saliency, which represents the user's level of attention, in the input image. As described above, the image quality will deteriorate in an area (pixel) where the direction of the user's line of sight and the direction of the motion vector do not coincide. Thus, the area where the direction of the user's line of sight and the direction of the motion vector do not coincide is detected by detecting the low visual saliency area having a visual saliency. Note that details regarding the low visual saliency area detection unit 3 will be described later.

The motion vector correction unit 4 corrects the motion vector detected by the motion vector detection unit 2 so that it decreases in the low visual saliency area detected by the low visual saliency area detection unit 3. The motion vector correction unit 4 corrects the motion vector in the low visual saliency area so that it decreases according to the low level ratio of the visual saliency.

The motion compensation unit 5 performs motion compensation based on the motion vector that was corrected by the motion vector correction unit 4. Specifically, the motion compensation unit 5 performs motion compensation processing based on the motion vector corrected by the motion vector correction unit 4, generates interpolation frame image data to be interpolated between time-sequential frames, and interpolates the generated interpolation frame image data between the frames.

In comparison to a CRT (Cathode Ray Tube) display device, a liquid crystal display device has a drawback referred to as a motion blur where, when a moving image is displayed, the viewer perceives the contour of the moving portion as a blur. Thus, the motion compensation unit 5 converts the frame rate (number of frames) and alleviates the blur by interpolating an image between the frames.

Note that the motion compensation processing divides the target frame image data and the previous frame image data into macro blocks (for instance, blocks of 16 pixels×16 lines), and estimates the frame image data between the frames from the previous frame image data based on the motion vector which shows the moving direction and shift of the corresponding macro blocks between the target frame image data and the previous frame image data.

The motion compensation unit 5 generates the interpolation frame image data to be interpolated between the frames based on the motion compensation using the motion vector that was corrected by the motion vector correction unit 4, sequentially outputs the generated interpolation frame image data together with the input image, and thereby converts the frame rate of the input image, for example, from 60 frames/second to 120 frames/second.

The image display unit 6 comprises, for example, a color filter, a polarizer, a backlight device, a liquid crystal panel and a panel drive circuit, and displays video images by applying scanning signals and data signals to the liquid crystal panel based on the frame image data that was compensated by the motion compensation unit 5.

The configuration of the low visual saliency area detection unit 3 of FIG. 1 is now explained in detail. The low visual saliency area detection unit 3 detects the low visual saliency area based on the contrast of the input image. Since the user's visual saliency is low in the low contrast area in comparison to the high contrast area, the low visual saliency area can be detected based on the contrast of the input image. Thus, the low visual saliency area detection unit 3 detects the edge of the input image, and detects the area where an edge is not detected as the low contrast area, or the low visual saliency area.

For example, in a video image with a foreground image remaining stationary at the center part of the screen and a background image that is moving, if the luminance of the edge of the background image is low, the background image can be determined as a low visual saliency area having a low visual saliency. Thus, the low visual saliency area detection unit 3 detects an edge from the input image, and detects, as the low visual saliency area, an area in which the luminance of the detected edge is smaller than a predetermined threshold.

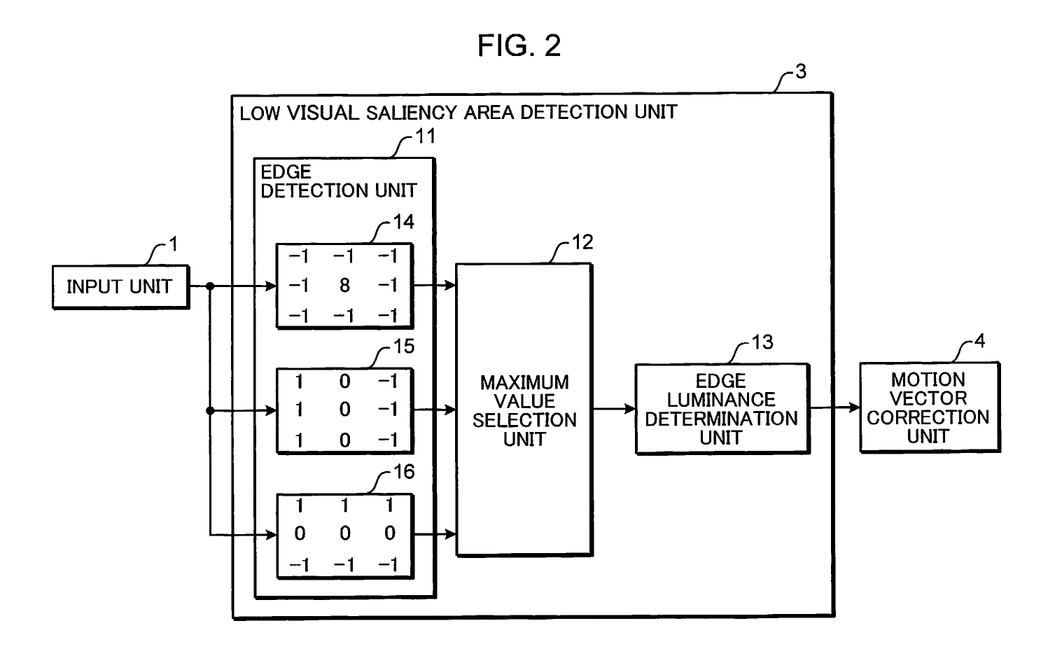

FIG. 2 is a diagram showing the specific configuration of the low visual saliency area detection unit 3 shown in FIG. 1. The low visual saliency area detection unit 3 shown in FIG. 2 comprises an edge detection unit 11, a maximum value selection unit 12 and an edge luminance determination unit 13.

The edge detection unit 11 detects an edge from the input image. The edge detection unit 11 comprises a Laplacian filter 14, a vertical direction Prewitt filter 15 and a horizontal direction Prewitt filter 16.

The Laplacian filter 14 is a secondary differentiation filter, and detects an edge in the input image. The Laplacian filter 14 respectively multiplies the coefficients shown in FIG. 2 to the luminance value of the nine pixels (up, down, left, right, diagonal) with a certain notice pixel at the center, and sets a value obtained by totaling the multiplication results as the new luminance value. The edge in the input image is thereby extracted.

The vertical direction Prewitt filter 15 is a primary differentiation filter, and detects only a vertical edge in the input image. The vertical direction Prewitt filter 15 respectively multiplies the coefficients shown in FIG. 2 to the luminance value of the nine pixels (up, down, left, right, diagonal) with a certain notice pixel at the center, and sets a value obtained by totaling the multiplication results as the new luminance value. Only the vertical edge in the input image is thereby extracted.

The horizontal direction Prewitt filter 16 is a primary differentiation filter, and detects only a horizontal edge in the input image. The horizontal direction Prewitt filter 16 respectively multiplies the coefficients shown in FIG. 2 to the luminance value of the nine pixels (up, down, left, right, diagonal) with a certain notice pixel at the center, and sets a value obtained by totaling the multiplication results as the new luminance value. Only the horizontal edge in the input image is thereby extracted.

The maximum value selection unit 12 selects the maximum value among the luminance values of the pixels of the respective edges that were detected by the Laplacian filter 14, the vertical direction Prewitt filter 15 and the horizontal direction Prewitt filter 16.

The edge luminance determination unit 13 determines the correction gain of the motion vector according to the luminance value that was selected by the maximum value selection unit 12, and outputs this to the motion vector correction unit 4. When the luminance value selected by the maximum value selection unit 12 is smaller than a predetermined threshold, the edge luminance determination unit 13 detects that pixel as a low visual saliency area, and determines the correction gain E so that the motion vector decreases as the luminance value decreases.

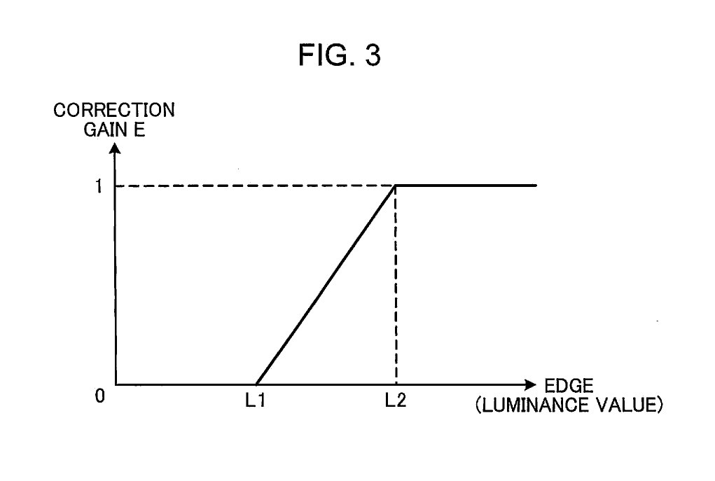

FIG. 3 is a diagram showing the relation of the luminance value of the edge and the correction gain E in the first embodiment. As shown in FIG. 3, the correction gain E is 0 while the luminance value is between 0 and L1, the correction gain E linearly increases from 0 to 1 while the luminance value is between L1 and L2, and the correction gain E is 1 when the luminance value becomes L2 or higher. The edge luminance determination unit 13 determines the correction gain E so that the motion vector decreases as the amplitude of the respective pixels of the edges detected by the edge detection unit 11 decreases.

The motion vector correction unit 4 corrects the motion vector based on the correction gain E that is output by the edge luminance determination unit 13. Specifically, the motion vector correction unit 4 calculates the corrected motion vector by multiplying the correction gain E output by the edge luminance determination unit 13 by the motion vector detected by the motion vector detection unit 2.

Note that, in this embodiment, the edge luminance determination unit 13 corresponds to an example of the first correction gain determination unit.

Moreover, in this embodiment, the low visual saliency area detection unit 3 detects an edge of the input image and determines the correction gain according to the luminance level of the detected edge, but the present invention is not limited thereto. The low visual saliency area detection unit 3 can also detect, as the low visual saliency area, an area in which the contrast ratio is lower than a predetermined threshold in the input image. In the foregoing case, the low visual saliency area detection unit 3 divides the input image into a plurality of areas (for example, 3×3 pixels), detects the maximum value Lmax and the minimum value Lmin of the luminance in each of the divided areas, and thereby calculates the contrast ratio (Lmax−Lmin)/(Lmax+Lmin). In addition, the low visual saliency area detection unit 3 detects, as the low visual saliency area, an area in which the calculated contrast ratio is lower than a predetermined threshold, and determines the correction gain of the motion vector of the respective pixels in that low visual saliency area according to the level of the calculated contrast ratio.

A different configuration of the low visual saliency area detection unit 3 is now explained. For example, in a video image with a foreground image remaining stationary at the center part of the screen and a background image that is moving, if the saturation of the background image is smaller than the saturation of the foreground image, the background image can be determined as a low visual saliency area having a low visual saliency. Thus, the low visual saliency area detection unit 3 can detect, as the low visual saliency area, an area in which the saturation is lower than a predetermined threshold in the input image. The first modified example of detecting the low visual saliency area by using the saturation is now explained.

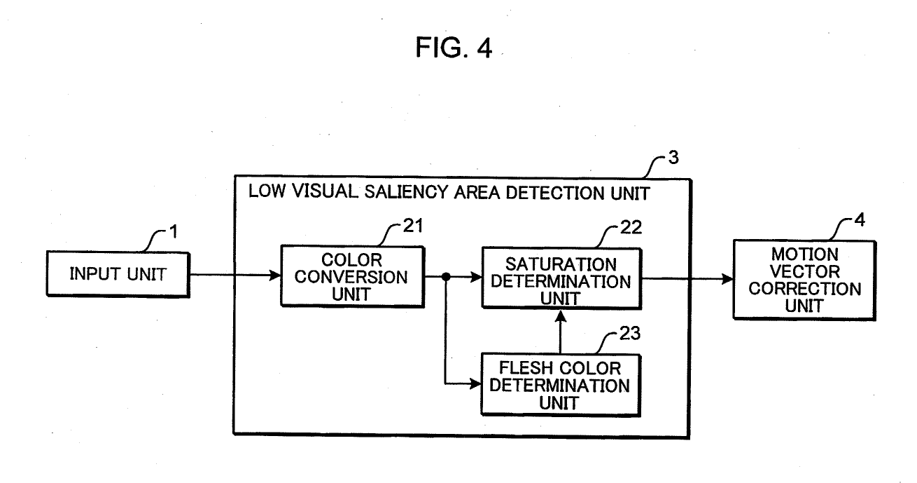

FIG. 4 is a diagram showing a specific configuration of the low visual saliency area detection unit 3 in the first modified example. The low visual saliency area detection unit 3 shown in FIG. 4 comprises a color conversion unit 21, a saturation determination unit 22 and a flesh color determination unit 23.

The color conversion unit 21 converts an input image represented by the RGB (R: red, G: green, B: blue) color space into an input image represented by the HSV (H: hue, S: saturation, V: value) color space. Note that, since the method of converting from the RGB color space to the HSV color space is a known method, the explanation thereof is omitted.

The saturation determination unit 22 determines the correction gain of the motion vector according to the saturation in the input image that was subject to color conversion by the color conversion unit 21, and outputs this to the motion vector correction unit 4. When the saturation of the respective pixels is smaller than a predetermined threshold in the input image that was subject to color conversion by the color conversion unit 21, the saturation determination unit 22 detects that pixel as a low visual saliency area, and determines the correction gain S so that the motion vector decreases.

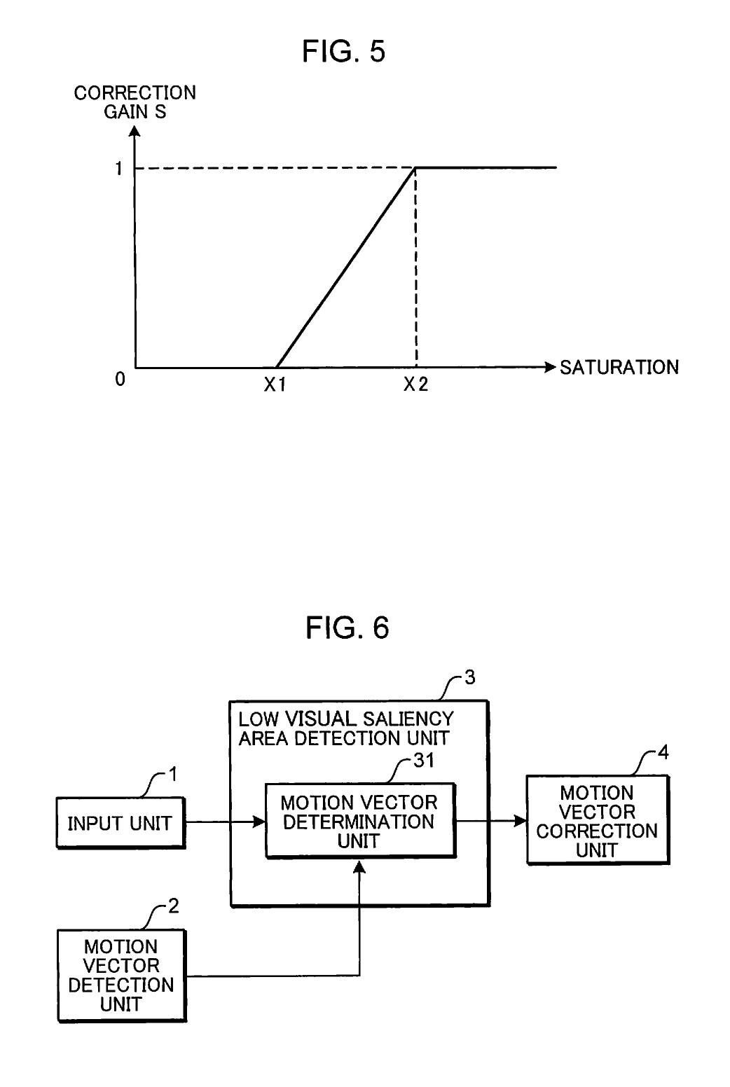

FIG. 5 is a diagram showing the relation of the saturation and the correction gain S in the first modified example. As shown in FIG. 5, the correction gain S is 0 while the saturation is between 0 and X1, the correction gain S linearly increases from 0 to 1 while the saturation is between X1 and X2, and the correction gain S is 1 when the saturation becomes X2 or higher. The saturation determination unit 22 determines the correction gain S so that the motion vector decreases as the saturation of the respective pixels configuring the input image decreases.

The flesh color determination unit 23 determines whether the respective pixels are a flesh color in the input image that was subject to color conversion by the color conversion unit 21. The flesh color determination unit 23 determines whether the hue of the respective pixels is within a range of the value representing a flesh color in the input image that was subject to color conversion by the color conversion unit 21, and, when the hue of a pixel is within a range of the value representing a flesh color, determines that the pixel is a flesh color, and, when the hue of a pixel is not within a range of the value representing a flesh color, determines that the pixel is not a flesh color. Note that, when a pixel is determined to be a flesh color by the flesh color determination unit 23, the saturation determination unit 22 determines the correction gain S to be 1 irrespective of the saturation.

The motion vector correction unit 4 corrects the motion vector based on the correction gain S that is output by the saturation determination unit 22. Specifically, the motion vector correction unit 4 calculates the corrected motion vector by multiplying the correction gain S output by the saturation determination unit 22 by the motion vector detected by the motion vector detection unit 2. When a pixel is determined to be a flesh color by the flesh color determination unit 23, since the motion vector is multiplied by 1, the motion vector correction unit 4 outputs the motion vector without correcting it.

Note that, in this embodiment, the saturation determination unit 22 corresponds to an example of the second correction gain determination unit.

Moreover, in the first modified example of this embodiment, the low visual saliency area detection unit 3 comprises the flesh color determination unit 23, but the present invention is not limited thereto, and the low visual saliency area detection unit 3 may only comprise the color conversion unit 21 and the saturation determination unit 22 without comprising the flesh color determination unit 23.

Another different configuration of the low visual saliency area detection unit 3 is now explained. For example, in a video image with a foreground image remaining stationary at the center part of the screen and a background image that is moving, when the background image is moving at a fast speed relative to the foreground image, the background image can be determined as a low visual saliency area having a low visual saliency. Thus, the low visual saliency area detection unit 3 can detect, as the low visual saliency area, an area in which the level of the motion vector detected by the motion vector detection unit 2 is greater than a predetermined threshold in the input image. The second modified example of detecting the low visual saliency area by using the motion vector is now explained.

FIG. 6 is a diagram showing a specific configuration of the low visual saliency area detection unit 3 in the second modified example. The low visual saliency area detection unit 3 shown in FIG. 6 comprises a motion vector determination unit 31.

The motion vector determination unit 31 determines the correction gain of the motion vector according to the level of the motion vector that was detected by the motion vector detection unit 2, and outputs this to the motion vector correction unit 4. When the level of the motion vector of the respective pixels is greater than a predetermined threshold in the input image, the motion vector determination unit 31 detects that pixel as a low visual saliency area, and determines the correction gain Sp so that the motion vector decreases.

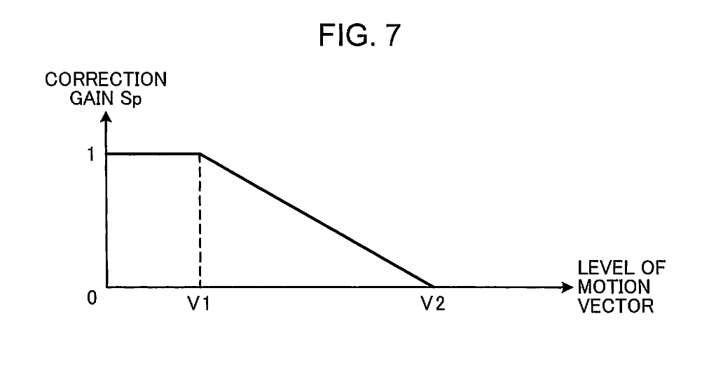

FIG. 7 is a diagram showing the relation of the level of the motion vector and the correction gain Sp in the second modified example. As shown in FIG. 7, the correction gain Sp is 1 while the level of the motion vector is between 0 and V1, the correction gain Sp linearly decreases from 1 to 0 while the level of the motion vector is between V1 and V2, and the correction gain Sp is 0 when the level of the motion vector becomes V2 or higher. The motion vector determination unit 31 determines the correction gain Sp so that the motion vector decreases as the level of the motion vector that was detected by the motion vector detection unit 2 of the respective pixels configuring the input image increases.

The motion vector correction unit 4 corrects the motion vector based on the correction gain Sp that is output by the motion vector determination unit 31. Specifically, the motion vector correction unit 4 calculates the corrected motion vector by multiplying the correction gain Sp output by the motion vector determination unit 31 by the motion vector detected by the motion vector detection unit 2.

Note that, in this embodiment, the motion vector determination unit 31 corresponds to an example of the third correction gain determination unit.

Accordingly, based on the motion compensation using the motion vector that was corrected by the motion vector correction unit 4, the interpolation frame image data to be interpolated between the frames is generated, and the generated interpolation frame image data is sequentially output together with the input image. Thus, it is possible to generate the interpolation frame image data according to the movement of the user's line of sight. Thus, the video resolution is improved and the degradation of image quality is inhibited.

Note that, in the first embodiment, the low visual saliency area is detected based on luminance of the edge, saturation, or level of the motion vector, but the present invention is not limited thereto, and the low visual saliency area can also be detected based on at least one among luminance of the edge, saturation, or level of the motion vector.

For example, when correcting the motion vector based on all factors of luminance of the edge, saturation and level of the motion vector, the motion vector correction unit 4 calculates the corrected motion vector based Formula (1) below from the correction gain E that was determined based on the luminance of the edge, the correction gain S that was determined based on the saturation, the correction gain Sp that was determined based on the level of the motion vector, and the detected motion vector.

Corrected motion vector=(1−Tmp)×motion vector

(provided that Tmp=(1−correction gain E)×(1−correction gain S)×(1−correction gain Sp)) (1)

Accordingly, the motion vector can be corrected accurately by detecting the low visual saliency area based on luminance of the edge and saturation. Moreover, the motion vector can be more accurately corrected by correcting the motion vector based on at least one among luminance of the edge, saturation and level of the motion vector.

### Second Embodiment

In the second embodiment, a plasma display device is explained as an example of a video display device, but the video display device to which the present invention is applied is not particularly limited to this example and, for instance, can also be similarly applied to other video display devices so as long as it can divide one field or one frame into a plurality of sub fields and perform gray scale display.

Moreover, in the present specification, the description of “sub field” includes the meaning of “sub field period,” and the description of “emission of sub fields” includes the meaning of “emission of pixels in a sub field period.” Moreover, the sub field emission period means the sustaining period that light is being emitted based on a sustaining discharge so that it can be viewed by the viewer, and does not include the initialization period, writing period and other periods where emission that is viewable by the viewer is not being performed. The immediately preceding sub field non-emission period means the period where emission that is viewable by the viewer is not being performed, and includes the initialization period and the writing period where emission that is viewable by the viewer is not being performed, and the sustaining period where sustaining discharge is not being performed.

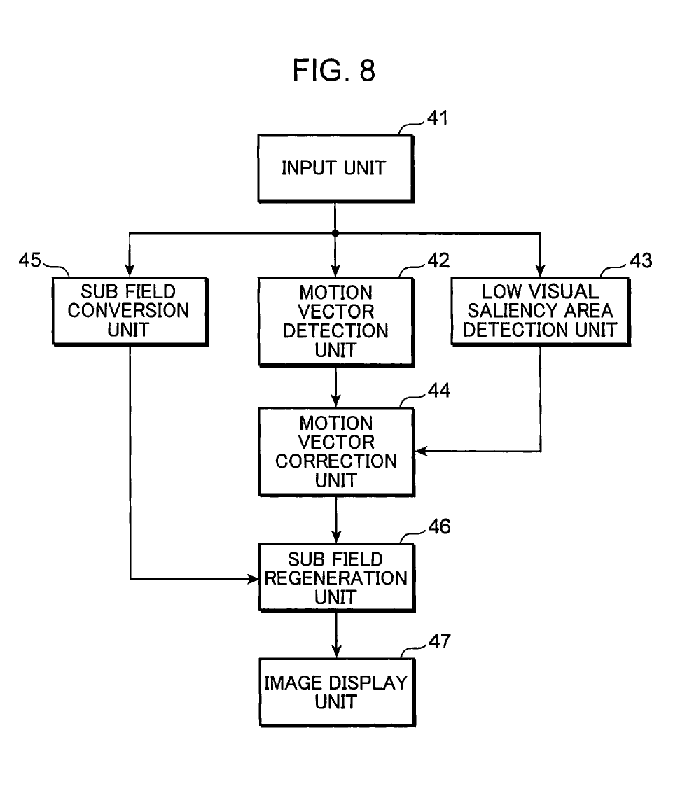

FIG. 8 is a block diagram showing the configuration of the video display device according to the second embodiment of the present invention. The video display device shown in FIG. 8 comprises an input unit 41, a motion vector detection unit 42, a low visual saliency area detection unit 43, a motion vector correction unit 44, a sub field conversion unit 45, a sub field regeneration unit 46 and an image display unit 47. Moreover, the motion vector detection unit 42, the low visual saliency area detection unit 43, the motion vector correction unit 44, the sub field conversion unit 45 and the sub field regeneration unit 46 configure a video processing device which processes input images so as to improve the quality level of the video image quality based on motion vectors.

The input unit 41 comprises, for example, a TV broadcast tuner, an image input terminal and a network connection terminal, and video image data is input into the input unit 41. The input unit 41 performs well-known conversion processing and the like to the input video image data, and outputs the frame image data, which was subject to conversion processing, to the motion vector detection unit 42, the low visual saliency area detection unit 43 and the sub field conversion unit 45.

The motion vector detection unit 42 is input with two frame image data which are temporally successive; for instance, image data of a frame N-1 and image data of a frame N (here, N is an integer), and the motion vector detection unit 42 detects the motion vector per pixel of the frame N by detecting the motion between these frames, and outputs this to the motion vector correction unit 44. As this motion vector detection method, a well-known motion vector detection method is adopted and, for example, a detection method based on the matching processing per block is used.

The low visual saliency area detection unit 43 detects a low visual saliency area having a low visual saliency, which represents the user's level of attention, in the input image. Note that details regarding the low visual saliency area detection unit 43 will be described later.

The motion vector correction unit 44 corrects the motion vector detected by the motion vector detection unit 42 so that it decreases in the low visual saliency area detected by the low visual saliency area detection unit 43. The motion vector correction unit 44 corrects the motion vector in the low visual saliency area so that it decreases according to the low level ratio of the visual saliency.

The sub field conversion unit 45 divides one field or one frame into a plurality of sub fields, and converts the input image into emission data of each sub field for performing gray scale display by combining an emission sub field which emits light and a non-emission sub field which does not emit light. The sub field conversion unit 45 sequentially converts one frame image data, or image data of one field, into emission data of the respective sub fields, and outputs this to the sub field regeneration unit 46.

The half-toning method of the video display device for expressing the gray scale using sub fields is now explained. One field is configured from K (here, K is an integer of 2 or more) sub fields, the respective sub fields are subject to predetermined weighting corresponding to the luminance, and the emission period is set so that the luminance of the respective sub fields will change according to the foregoing weighting. For example, when seven sub fields are used and weighting of two to the seventh power is performed, the weight of the first to seventh sub fields will be 1, 2, 4, 8, 16, 32, and 64, respectively, and, by combining the light-emitting state or the non-light-emitting state of the respective sub fields, video can be expressed within the scope of 0 to 127 shades of gray. Note that the division, weighting and arrangement sequence of the sub fields are not limited to the foregoing examples, and can be changed variously.

The sub field regeneration unit 46 generates rearranged emission data of the respective sub fields for each pixel of the frame N by spatially rearranging the emission data of the respective sub fields, which were converted by the sub field conversion unit 45, for each pixel of the frame N according to the motion vector that was corrected by the motion vector correction unit 44, and outputs this to the image display unit 47.

For example, as with the rearrangement method shown in FIG. 17, the sub field regeneration unit 46 identifies the sub fields to emit light among the sub fields of the respective pixels of the frame image to be displayed, and, according to the arrangement sequence of the sub fields, changes the emission data of the sub fields corresponding to the pixels positioned in a manner of being spatially moved rearward in a distance of the pixels corresponding to the motion vector to the emission data of the sub fields of the pixels before being moved so that the temporally preceding sub field moves a greater distance.

Note that the sub field rearrangement method is not limited to the foregoing example, and the method may be changed variously such as rearranging the emission data of the sub fields by collecting the emission data of the sub fields of pixels positioned in a manner of being spatially moved forward in a distance of the pixels corresponding to the motion vector as the emission data of the sub fields of the respective pixels of the frame N so that the temporally preceding sub field moves a greater distance.

The image display unit 47 comprises, for example, a plasma display panel and a panel drive circuit, and displays a video image by controlling the ON/OFF of the lighting of the respective sub fields of the respective pixels of the plasma display panel based on the rearranged emission data.

The correction processing of the rearranged emission data by the video display device configured as described above is now explained in detail. Foremost, video image data is input into the input unit 41, the input unit 41 performs predetermined conversion processing to the input video image data, and outputs the frame image data, which was subject to conversion processing, to the motion vector detection unit 42, the low visual saliency area detection unit 43 and the sub field conversion unit 45.

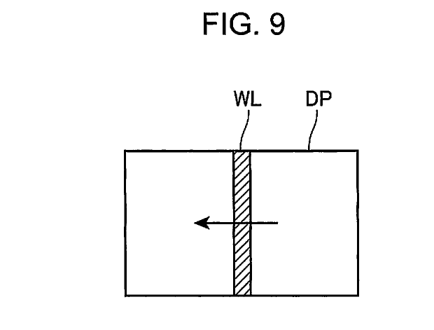

FIG. 9 is a schematic diagram showing an example of the video image data. The video image data shown in FIG. 9 is video in which the entire screen of the display screen DP is displayed in a black color (minimum luminance level) as the background, and one line (line in which one pixel is arranged in one line in the vertical direction) WL in a white color (maximum luminance level) as the foreground moves from right to left on the display screen DP and, for example, this video image data is input into the input unit 41.

Subsequently, the sub field conversion unit 45 sequentially converts the frame image data into emission data of the first to seventh sub fields SF1 to SF7 for each pixel, and outputs this to the sub field regeneration unit 46.

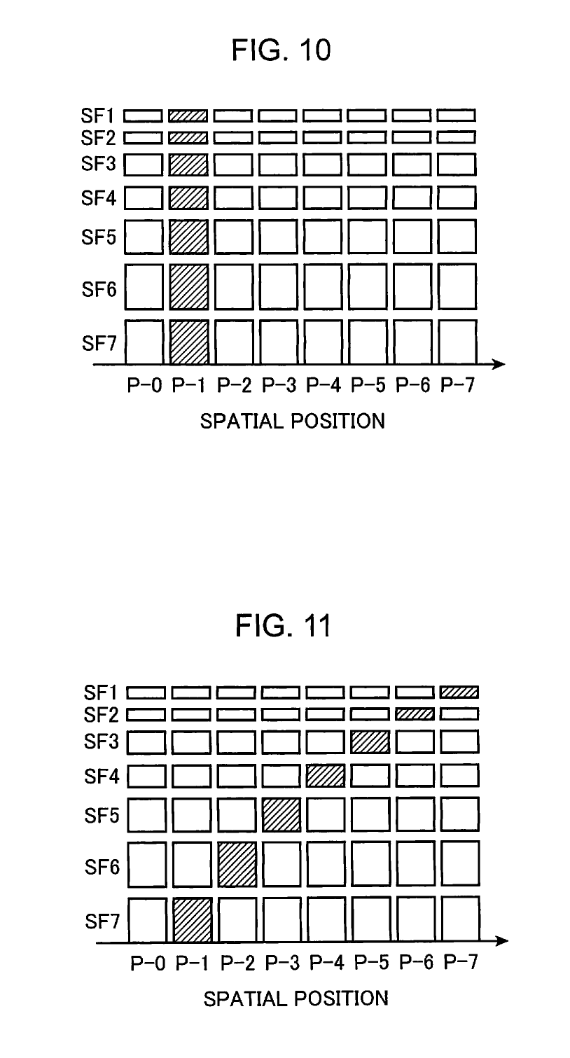

FIG. 10 is a schematic diagram showing an example of the emission data of the sub fields relative to the video image data shown in FIG. 9. For example, when one white line WL is positioned on the pixel P-1 as the spatial position on the display screen DP (position in the horizontal direction x), as shown in FIG. 10, the sub field conversion unit 45 generates emission data in which the first to seventh sub fields SF1 to SF7 of the pixel P-1 are set to a light-emitting state (sub fields that are hatched in the diagram), and the first to seventh sub fields SF1 to SF7 of the other pixels P-0, P-2 to P-7 are set to a non-light-emitting state (sub fields that are outlined in the diagram). Accordingly, when the sub fields are not rearranged, the image based on the sub fields shown in FIG. 10 is displayed on the display screen.

Parallel to the creation of the emission data of the foregoing first to seventh sub fields SF1 to SF7, the motion vector detection unit 42 detects the motion vector for each pixel between two temporally successive frame image data, and outputs this to the motion vector correction unit 44.

Moreover, the low visual saliency area detection unit 43 detects a low visual saliency area having a low visual saliency, which represents the user's level of attention, in the input image. The motion vector correction unit 44 corrects the motion vector detected by the motion vector detection unit 42 so that it decreases in the low visual saliency area detected by the low visual saliency area detection unit 43, and outputs this to the sub field regeneration unit 46.

Subsequently, the sub field regeneration unit 46 identifies the sub fields to emit light among the sub fields of the respective pixels of the frame image to be displayed, and, according to the arrangement sequence of the first to seventh sub fields SF1 to SF7, changes the emission data of the sub fields corresponding to the pixels positioned in a manner of being spatially moved rearward in a distance of the pixels corresponding to the motion vector to the emission data of the sub fields of the pixels before being moved so that the temporally preceding sub field moves a greater distance.

FIG. 11 is a schematic diagram showing an example of the rearranged emission data obtained by rearranging the emission data of the sub fields shown in FIG. 10. For example, when the shift of the pixels corresponding to the motion vector is seven pixels, as shown in FIG. 11, the sub field regeneration unit 46 moves the emission data (light-emitting state) of the first to sixth sub fields SF1 to SF6 of the pixel P-1 rightward in a distance corresponding to six pixels to one pixel, thereby changes the emission data of the first sub field SF1 of the pixel P-7 from a non-light-emitting state to a light-emitting state, changes the emission data of the second sub field SF2 of the pixel P-6 from a non-light-emitting state to a light-emitting state, changes the emission data of the third sub field SF3 of the pixel P-5 from a non-light-emitting state to a light-emitting state, changes the emission data of the fourth sub field SF4 of the pixel P-4 from a non-light-emitting state to a light-emitting state, changes the emission state of the fifth sub field SF5 of the pixel P-3 from a non-light-emitting state to a light-emitting state, changes the emission data of the sixth sub field SF6 of the pixel P-2 from a non-light-emitting state to a light-emitting state, changes the emission data of the first to sixth sub fields SF1 to SF6 of the pixel P-1 from a light-emitting state to a non-light-emitting state, and does not change the emission data of the seventh sub field SF7 of the pixel P-1.

The sub fields are regenerated according to the motion vector as described above, and the generation of video blur and dynamic false contours is inhibited, and the video resolution is improved.

The configuration of the low visual saliency area detection unit 43 of FIG. 8 is now explained in detail. For example, in a video image with a foreground image remaining stationary at the center part of the screen and a background image that is moving, if the luminance of the background image has an intermediate gray scale, the background image can be determined as a low visual saliency area having a low visual saliency. Thus, the low visual saliency area detection unit 43 detects, as the low visual saliency area, an area having luminance of an intermediate gray scale in the input image.

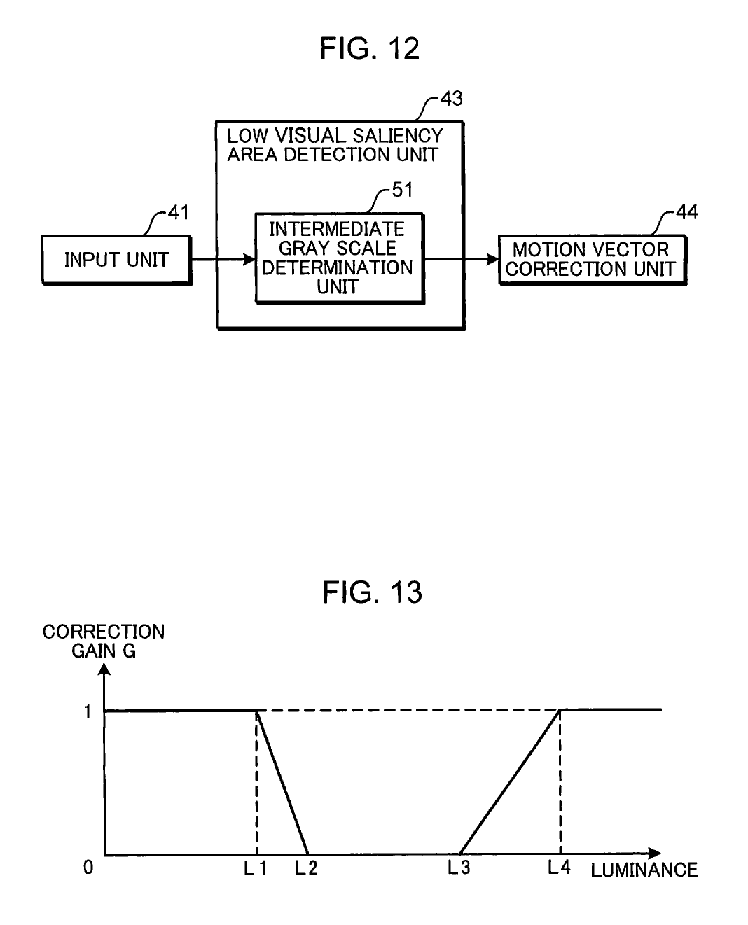

FIG. 12 is a diagram showing a specific configuration of the low visual saliency area detection unit 43 shown in FIG. 8. The low visual saliency area detection unit 43 shown in FIG. 12 comprises an intermediate gray scale determination unit 51.

The intermediate gray scale determination unit 51 detects pixels having an intermediate gray scale from the input image that was input from the input unit 41, determines the correction gain of the motion vector of the detected pixels having an intermediate gray scale, and outputs this to the motion vector correction unit 44. When the luminance of the respective pixels has an intermediate gray scale in the input image, the intermediate gray scale determination unit 51 detects that pixel as the low visual saliency area and determines the correction gain G so that the motion vector decreases.

FIG. 13 is a diagram showing the relation between the luminance and the correction gain G in the second embodiment. As shown in FIG. 13, the correction gain G is 1 while the luminance is between 0 and L2, the correction gain G linearly decreases from 1 to 0 while the luminance is between L1 and L2, the correction gain G is 0 while the luminance is between L1 and L2, the correction gain G linearly increases from 0 to 1 when the luminance is between L3 and L4, and the correction gain G is 1 when the luminance becomes L4 or higher. The luminance between L1 and L4 constitutes an intermediate gray scale. The intermediate gray scale determination unit 51 determines the correction gain G so that the motion vector decreases when the respective pixels configuring the input image has luminance of an intermediate gray scale.

Note that, in FIG. 13, the gradient in the luminance L1 to L2 and the gradient in the luminance L3 to L4 are different, but the present invention is not limited thereto, and the gradient in the luminance L1 to L2 and the gradient in the luminance L3 to L4 may be the same. In addition, the gradient in the luminance L1 to L2 and the gradient in the luminance L3 to L4 may be arbitrarily set.

The motion vector correction unit 44 corrects the motion vector based on the correction gain G that is output by the intermediate gray scale determination unit 51. Specifically, the motion vector correction unit 44 calculates the corrected motion vector by multiplying the correction gain G output by the intermediate gray scale determination unit 51 by the motion vector detected by the motion vector detection unit 42.

Note that, in this embodiment, the intermediate gray scale determination unit 51 corresponds to an example of the fourth correction gain determination unit.

The regeneration of the sub fields based on the corrected motion vector is now explained.

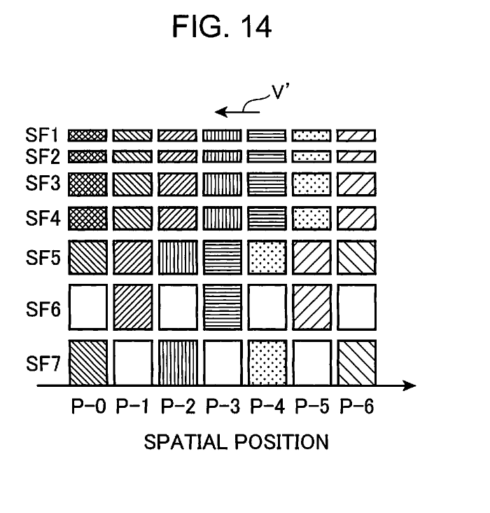

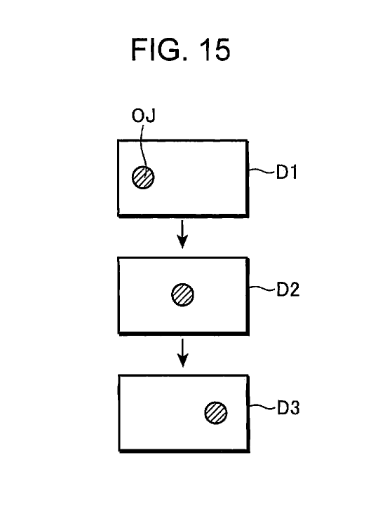

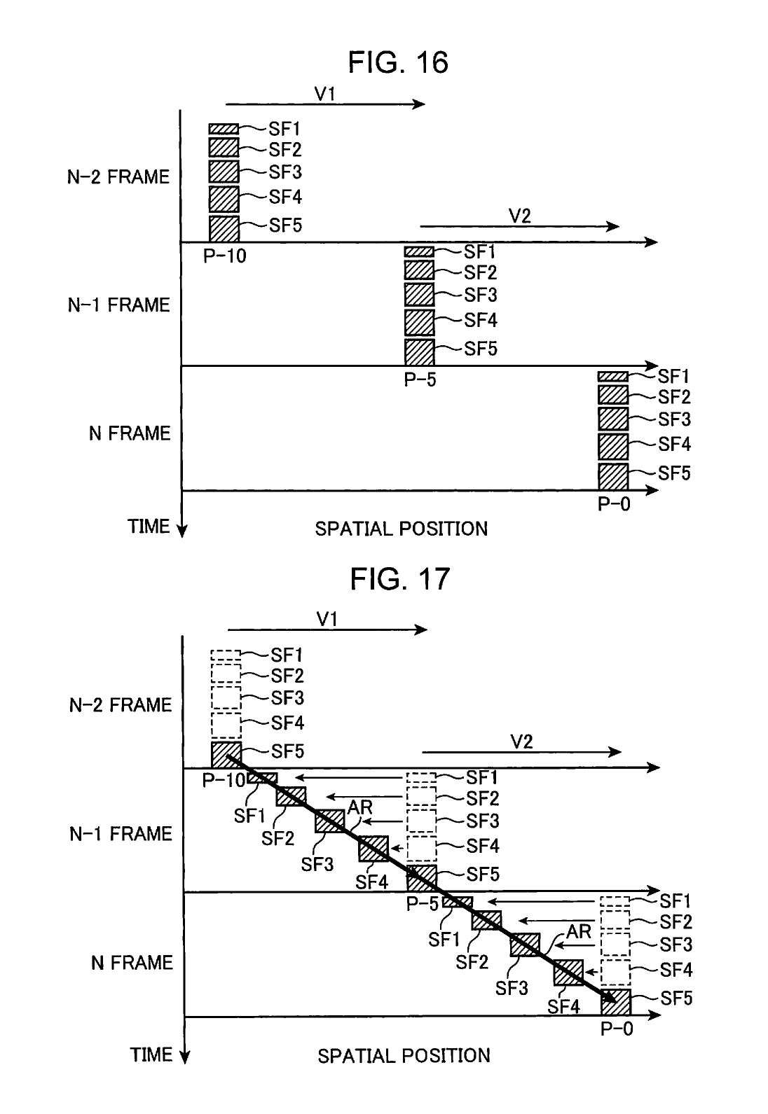

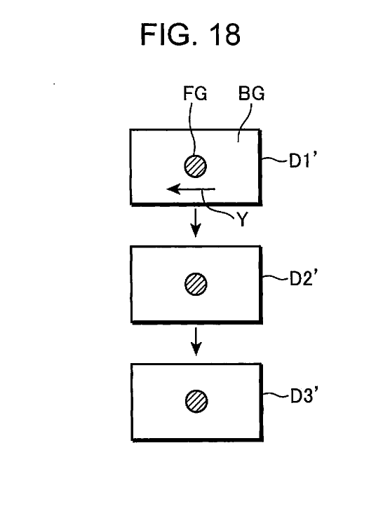

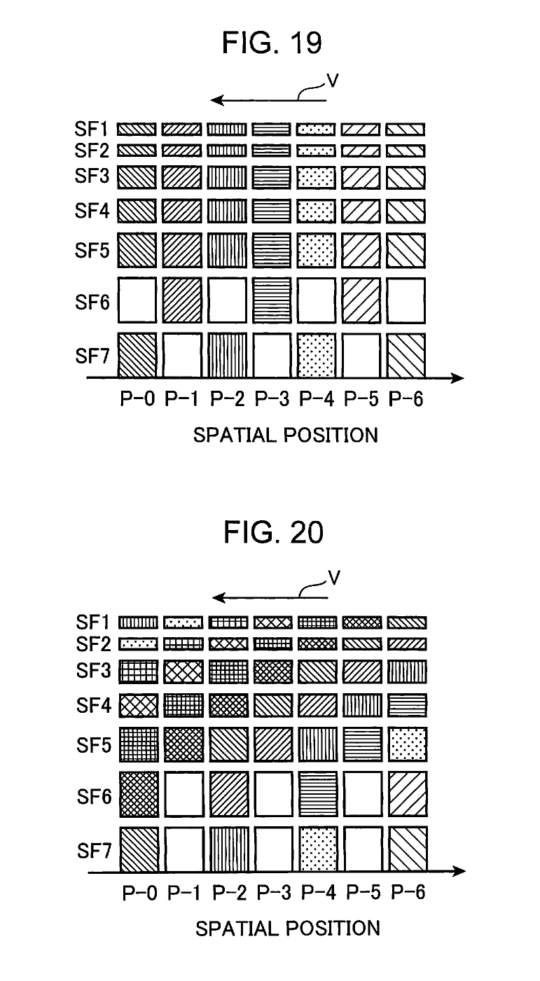

FIG. 14 is a schematic diagram explaining the emission data of the respective sub fields after rearranging the emission data of the respective sub fields shown in FIG. 19 based on the corrected motion vector.

The sub field regeneration unit 46 identifies the sub fields to emit light among the sub fields of the respective pixels of the frame image to be displayed, and, according to the arrangement sequence of the first to seventh sub fields SF1 to SF7, changes the emission data of the sub fields corresponding to the pixels positioned in a manner of being spatially moved rearward in a distance of the pixels corresponding to the motion vector to the emission data of the sub fields of the pixels before being moved so that the temporally preceding sub field moves a greater distance.

When the shift of pixels corresponding to the corrected motion vector V′ is two pixels while the shift of pixels corresponding to the motion vector V before correction is seven pixels, as shown in FIG. 14, the emission data of the first to fourth sub fields SF1 to SF4 of the pixels P-0 to P-6 moves rightward in a distance corresponding to one pixel, and the emission data of the fifth to seventh sub fields SF5 to SF7 of the pixels P-0 to P-6 does not move. Consequently, the emission data of the sixth sub field SF6 of the pixels P-0, P-2, P-4, P-6 in a non-light-emitting state is not changed, and the emission data of the sixth sub field SF6 of the pixels P-1, P-3, P-5 in a light-emitting state is not changed either.

Accordingly, even if the sub fields are rearranged, the emission data of the sub fields before rearrangement and the emission data of the rearranged sub fields will be the same in an area where the direction of the user's line of sight and the direction of the motion vector are different. In the foregoing case, the pixels P-0 to P6 will emit light with uniform brightness, and roughness will not arise. Thus, the video resolution is improved and the degradation of image quality is inhibited.

Note that, in the second embodiment, the low visual saliency area is detected based on whether the image has an intermediate gray scale, but the present invention is not limited thereto, and the low visual saliency area can also be detected based on at least one among luminance of the edge, saturation, level of the motion vector, and whether the image has an intermediate gray scale.

For example, when correcting the motion vector based on all factors of luminance of the edge, saturation, level of the motion vector, and whether the image has an intermediate gray scale, the motion vector correction unit 44 calculates the corrected motion vector based on Formula (2) below from the correction gain E that was determined based on the luminance of the edge, the correction gain S that was determined based on the saturation, the correction gain Sp that was determined based on the level of the motion vector, the correction gain G that was determined based on whether the image has an intermediate gray scale, and the detected motion vector.

Corrected motion vector=(1−Tmp)×motion vector

(provided that Tmp=(1−correction gain E)×(1−correction gain S)×(1−correction gain Sp)×(1−correction gain G)) (2)

Accordingly, the motion vector can be corrected accurately by detecting the low visual saliency area based on luminance of the edge and saturation. Moreover, the motion vector can be more accurately corrected by detecting the low visual saliency area based on luminance of the edge, saturation, level of the motion vector and whether the image has an intermediate gray scale. In addition, the motion vector can be more accurately corrected by correcting the motion vector based on at least one among luminance of the edge, saturation, level of the motion vector and whether the image has an intermediate gray scale.

Moreover, in the first and second embodiments, a case where the background image is scrolled in the horizontal direction was explained, but the present invention is not limited thereto, and the present invention can be similarly applied to cases where the background image is scrolled in the vertical direction or the oblique direction.

Moreover, if there is no foreground image remaining stationary and the overall screen is scrolled, the correction of the motion vector can be prohibited. In the foregoing case, the video processing device further comprises a scroll determination unit which determines whether the overall screen is being scrolled, and, when it is determined that the overall screen is being scrolled by the scroll determination unit, the motion vector correction unit outputs the motion vector that was detected by the motion vector detection unit without correcting it.

In addition, in the first and second embodiments, the low visual saliency area is detected based on the input image, but the present invention is not limited thereto, and a spectacle-type line of sight detection device may be used to detect a low visual saliency area having a low visual saliency, which represents the user's level of attention. In the foregoing case, the video processing device further comprises a line of sight detection device which detects the movement of the user's line of sight in the screen, and the low visual saliency area detection unit detects the low visual saliency area having a low visual saliency based on the movement of the user's line of sight that was detected by the line of sight detection device.

Note that the foregoing specific embodiments mainly include the invention configured as described below.

The video processing device according to one aspect of the present invention comprises a motion vector detection unit which detects a motion vector using at least two or more time-sequential input images, a low visual saliency area detection unit which detects a low visual saliency area having a low visual saliency in the input image, and a motion vector correction unit which corrects the motion vector detected by the motion vector detection unit so that the motion vector decreases in the low visual saliency area detected by the low visual saliency area detection unit.

According to the foregoing configuration, the motion vector is detected using at least two or more time-sequential input images, the low visual saliency area having a low visual saliency, which represents the user's level of attention, in the input image is detected, and correction is performed so that the detected motion vector decreases in the detected low visual saliency area.

Accordingly, since correction is performed so that the motion vector decreases in the low visual saliency area, which represents the user's level of attention, in the input image, it is possible to inhibit the degradation of image quality that occurs in the low visual saliency area having a low visual saliency, and additionally improve the video resolution.

Moreover, with the foregoing video processing device, preferably, the low visual saliency area detection unit detects the low visual saliency area based on a contrast of the input image.

According to the foregoing configuration, the low visual saliency area is detected based on the contrast of the input image. Since the user's visual saliency is lower in the low contrast area in comparison to the high contrast area, the low visual saliency area can be detected based on the contrast of the input image.

Moreover, with the foregoing video processing device, preferably, the low visual saliency area detection unit detects an edge from the input image, and detects, as the low visual saliency area, an area in which luminance of the detected edge is smaller than a predetermined threshold.

According to the foregoing configuration, since an edge is detected from the input image, and an area in which luminance of the detected edge is smaller than a predetermined threshold is detected as the low visual saliency area, the low visual saliency area having a low visual saliency can be detected reliably.

Moreover, with the foregoing video processing device, preferably, the low visual saliency area detection unit includes an edge detection unit which detects an edge from the input image, and a first correction gain determination unit which determines a correction gain so that the motion vector decreases as an amplitude of each pixel of the edge detected by the edge detection unit decreases, and the motion vector correction unit corrects the motion vector to be decreased by multiplying the correction gain determined by the first correction gain determination unit by the motion vector detected by the motion vector detection unit.

According to the foregoing configuration, an edge is detected from the input image, and the correction gain is determined so that the motion vector decreases as the amplitude of each pixel of the detected edge decreases. In addition, correction is performed so that the motion vector decreases by multiplying the determined correction gain by the detected motion vector. Accordingly, the motion vector can be reliably corrected based on the luminance of the edge that is detected from the input image.

Moreover, with the foregoing video processing device, preferably, the low visual saliency area detection unit detects, as the low visual saliency area, an area in which saturation in the input image is smaller than a predetermined threshold.

According to the foregoing configuration, since an area in which saturation in the input image is smaller than a predetermined threshold is detected as the low visual saliency area, the low visual saliency area having a low visual saliency can be detected reliably.

Moreover, with the foregoing video processing device, preferably, the low visual saliency area detection unit includes a second correction gain determination unit which determines a correction gain so that the motion vector decreases as the saturation of each pixel configuring the input image decreases, and the motion vector correction unit corrects the motion vector to be decreased by multiplying the correction gain determined by the second correction gain determination unit by the motion vector detected by the motion vector detection unit.

According to the foregoing configuration, the correction gain is determined so that the motion vector decreases as the saturation of each pixel configuring the input image decreases. In addition, correction is performed so that the motion vector decreases by multiplying the determined correction gain by the detected motion vector. Accordingly, the motion vector can be reliably corrected based on the saturation of the respective pixels configuring the input image.

Moreover, with the foregoing video processing device, preferably, the low visual saliency area detection unit detects, as the low visual saliency area, an area in which a level of the motion vector detected by the motion vector detection unit in the input image is greater than a predetermined threshold.

According to the foregoing configuration, since an area in which the level of the motion vector detected by the motion vector detection unit in the input image is greater than a predetermined threshold is detected as the low visual saliency area, the low visual saliency area having a low visual saliency can be detected reliably.

Moreover, with the foregoing video processing device, preferably, the low visual saliency area detection unit includes a third correction gain determination unit which determines a correction gain by which the motion vector decreases as a level of the motion vector detected by the motion vector determination unit of each pixel configuring the input image increases, and the motion vector correction unit corrects the motion vector to be decreased by multiplying the correction gain determined by the third correction gain determination unit by the motion vector detected by the motion vector detection unit.

According to the foregoing configuration, the correction gain is determined so that the motion vector decreases as the level of the motion vector of each pixel configuring the input image decreases. In addition, correction is performed so that the motion vector decreases by multiplying the determined correction gain by the detected motion vector. Accordingly, the motion vector can be reliably corrected based on the level of the motion vector of the respective pixels configuring the input image.

Moreover, preferably, the foregoing video processing device, preferably further comprises a sub field conversion unit which divides one field or one frame into a plurality of sub fields, and converts the input image into emission data of each sub field for performing gray scale display by combining an emission sub field which emits light and a non-emission sub field which does not emit light, and a regeneration unit which generates rearranged emission data of each sub field by spatially rearranging the emission data of each sub field converted by the sub field conversion unit according to the motion vector corrected by the motion vector correction unit.

According to the foregoing configuration, the rearranged emission data of the respective sub fields is generated by the input image being converted into emission data of the respective sub fields, and the converted emission data of the respective sub fields being spatially rearranged according to the corrected motion vector.

Accordingly, when the emission data of the respective sub fields is to be spatially rearranged, correction is performed so that the motion vector decreases in the low visual saliency area having a low visual saliency, which represents the user's level of attention, in the input image, it is possible to inhibit the degradation of the image quality that arises in the low visual saliency area having a low visual saliency, and additionally improve the video resolution.

Moreover, with the foregoing video processing device, preferably, the regeneration unit spatially rearranges the emission data of each sub field converted by the sub field conversion unit by changing emission data of a sub field corresponding to a pixel positioned in a manner of being spatially moved rearward in a distance of pixels corresponding to the motion vector corrected by the motion vector correction unit into emission data of the sub field of the pixel before being moved.

According to the foregoing configuration, the emission data of the respective sub fields is spatially rearranged by the emission data of the sub field corresponding to the pixel positioned in a manner of being spatially moved rearward in a distance of pixels corresponding to the motion vector being changed into emission data of the sub field of the pixel before being moved.

Accordingly, as a result of the emission data of the sub field corresponding to the pixel positioned in a manner of being spatially moved rearward in a distance of pixels corresponding to the motion vector being changed into emission data of the sub field of the pixel before being moved, when the emission data of the respective sub fields is to be spatially rearranged, it is possible to inhibit the degradation of the image quality that arises in the low visual saliency area having a low visual saliency, and additionally improve the video resolution.

Moreover, with the foregoing video processing device, preferably, the low visual saliency area detection unit detects, as the low visual saliency area, an area having luminance of an intermediate gray scale in the input image.

According to the foregoing configuration, since an area having luminance of an intermediate gray scale in the input image is detected as the low visual saliency area, the low visual saliency area having a low visual saliency can be detected reliably.

Moreover, with the foregoing video processing device, preferably, the low visual saliency area detection unit includes a fourth correction gain determination unit which determines a correction gain by which the motion vector decreases when each pixel configuring the input image has luminance of an intermediate gray scale, and the motion vector correction unit corrects the motion vector to be decreased by multiplying the correction gain determined by the fourth correction gain determination unit by the motion vector detected by the motion vector detection unit.

According to the foregoing configuration, the correction gain is determined so that the motion vector decreases when the respective pixels configuring the input image have luminance of an intermediate gray scale. In addition, correction is performed so that the motion vector decreases by multiplying the determined correction gain by the detected motion vector. Accordingly, the motion vector can be reliably corrected based on whether the respective pixels configuring the input image has luminance of an intermediate gray scale.

The video display device according to another aspect of the present invention comprises any one of the foregoing video processing devices, and a display unit which displays video by using rearranged emission data output from the video processing device.

In this video display device, since correction is performed so that the motion vector decreases in the low visual saliency area having a low visual saliency, which represents the user's level of attention, in the input image, it is possible to inhibit the degradation of image quality that occurs in the low visual saliency area having a low visual saliency, and additionally improve the video resolution.

Note that the specific embodiments and examples explained in the section of Description of Embodiments are provided merely for clarifying the technical contents of the present invention, and the present invention should not be narrowly interpreted by being limited to such specific examples, and may be variously modified and implemented within the scope of the spirit and claims of the present invention.

### INDUSTRIAL APPLICABILITY

The video processing device and the video display device according to the present invention can inhibit the degradation of image quality and improve the video resolution, and the present invention is effective as a video processing device which processes input images so as to improve the quality level of the video image quality based on motion vectors, and a video display device.

1. A video processing device, comprising:
a motion vector detection unit which detects a motion vector using at least two or more time-sequential input images;
a low visual saliency area detection unit which detects a low visual saliency area having a low visual saliency in the input image; and
a motion vector correction unit which corrects the motion vector detected by the motion vector detection unit so that the motion vector decreases in the low visual saliency area detected by the low visual saliency area detection unit.

2. The video processing device according to claim 1, wherein the low visual saliency area detection unit detects the low visual saliency area based on a contrast of the input image.

3. The video processing device according to claim 2,
wherein the low visual saliency area detection unit detects an edge from the input image, and detects, as the low visual saliency area, an area in which luminance of the detected edge is smaller than a predetermined threshold.

4. The video processing device according to claim 3, wherein
the low visual saliency area detection unit includes:
an edge detection unit which detects an edge from the input image; and
a first correction gain determination unit which determines a correction gain so that the motion vector decreases as an amplitude of each pixel of the edge detected by the edge detection unit decreases, wherein
the motion vector correction unit corrects the motion vector to be decreased by multiplying the correction gain determined by the first correction gain determination unit by the motion vector detected by the motion vector detection unit.

5. The video processing device according to claim 1 4, wherein the low visual saliency area detection unit detects, as the low visual saliency area, an area in which saturation in the input image is smaller than a predetermined threshold.

6. The video processing device according to claim 5, wherein
the low visual saliency area detection unit includes a second correction gain determination unit which determines a correction gain so that the motion vector decreases as the saturation of each pixel configuring the input image decreases, and
the motion vector correction unit corrects the motion vector so that the motion vector decreases by multiplying the correction gain determined by the second correction gain determination unit by the motion vector detected by the motion vector detection unit.

7. The video processing device according to claim 1, wherein the low visual saliency area detection unit detects, as the low visual saliency area, an area in which a level of the motion vector detected by the motion vector detection unit in the input image is greater than a predetermined threshold.

8. The video processing device according to claim 7, wherein
the low visual saliency area detection unit includes a third correction gain determination unit which determines a correction gain by which the motion vector decreases as a level of the motion vector detected by the motion vector determination unit of each pixel configuring the input image increases, and
the motion vector correction unit corrects the motion vector to be decreased by multiplying the correction gain determined by the third correction gain determination unit by the motion vector detected by the motion vector detection unit.

9. The video processing device according to claim 1, further comprising:
a sub field conversion unit which divides one field or one frame into a plurality of sub fields, and converts the input image into emission data of each sub field for performing gray scale display by combining an emission sub field which emits light and a non-emission sub field which does not emit light; and
a regeneration unit which generates rearranged emission data of each sub field by spatially rearranging the emission data of each sub field converted by the sub field conversion unit according to the motion vector corrected by the motion vector correction unit.

10. The video processing device according to claim 9,
wherein the regeneration unit spatially rearranges the emission data of each sub field converted by the sub field conversion unit by changing emission data of a sub field corresponding to a pixel positioned in a manner of being spatially moved rearward in a distance of pixels corresponding to the motion vector corrected by the motion vector correction unit into emission data of the sub field of the pixel before being moved.

11. The video processing device according to claim 9, wherein the low visual saliency area detection unit detects, as the low visual saliency area, an area having luminance of an intermediate gray scale in the input image.

12. The video processing device according to claim 11, wherein
the low visual saliency area detection unit includes a fourth correction gain determination unit which determines a correction gain by which the motion vector decreases when each pixel configuring the input image has luminance of an intermediate gray scale, and
the motion vector correction unit corrects the motion vector to be decreased by multiplying the correction gain determined by the fourth correction gain determination unit by the motion vector detected by the motion vector detection unit.

13. A video display device, comprising:
the video processing device according to claim 1; and
a display unit which displays video by using rearranged emission data output from the video processing device.
